(19) United States
(12) Patent Application Publication
(10) Pub. No.: US 2011/0100976 A1
(43) Pub. Date: May 5, 2011

(54) Gas Chromatograph

(75) Inventor: Shuichi KAWANA, Osaka-shi (JP)

(73) Assignee: SHIMADZU CORPORATION, Kyoto-shi (JP)

(21) Appl. No.: 12/912,642

(22) Filed: Oct. 26, 2010

(30) Foreign Application Priority Data
Oct. 30, 2009 (JP) 2009-251021

(51) Int. Cl. A21B 1/22

(52) U.S. Cl. 219/412

(57) ABSTRACT

The invention is provided to reduce wasteful energy consumption by performing a simple check that determines if the supply/exhaust openings of an oven are closed. The gas chromatograph comprises: memory means 24 that stores in advance the standard power consumption of the oven as a function of the set temperature, and a flap closure checking means 25 which compares the measured value of heater power consumption measured by heater power measurement means 23 at any set temperature against a standard power consumption for the set temperature that is determined from said function and, if the former exceeds the latter by more than a predetermined limit, judges that a closure failure of flap 13 has occurred.

### TECHNICAL FIELD

The present invention relates to a computer-controlled gas chromatograph.

### BACKGROUND ART

A gas chromatograph includes an oven where an analysis column is housed and heated under controlled heating to reach a temperature required for analysis. The oven is equipped with a heater and a temperature adjustment device that controls the power that is supplied to the heater. The over also includes an exhaust opening for discharging the heat in the oven to the outside for cooling purposes and a supply opening for introducing cool outside air into the oven. (These openings are collectively referred to hereinafter as “supply/exhaust openings.”) Each of the openings has a door (hereinafter “flap”) that can be opened and closed. The amount by which the opening is opened is controlled by a pulse motor or the like. (See for example patent literature 1.)

The temperature of the oven is generally controllable between room temperature and about 400 degrees Centigrade. At temperatures above approximately 50 degrees Centigrade, the temperature control is performed with the supply/exhaust openings almost completely closed. At temperatures below that in the room temperature range, the flaps are opened by an appropriate amount when controlling the temperature. After an analysis performed at a high temperature, the flaps are fully opened to lower the oven temperature in preparation for the next analysis.

An open-loop control is generally used to control the opening and closing of the flaps. As stated in Patent Literature 1, because of the problem of backlash which is characteristic of pulse motors, repeating the opening and closing of the flaps can result in a positional error where the flaps remain slightly opened when they should be closed, thus increasing heat loss. Despite this, the temperature adjustment device will usually automatically continue to increase the heater power so that the set temperature is maintained, and the analysis is performed without any problem.

However, when the temperature is set to a high temperature (e.g., 300 degrees Centigrade or more), if the flaps are not completely closed, problems can occur due to the heat loss including the inability or a very long time required to increase the oven temperature to the set temperature. To address these situations, some apparatuses are equipped with a system for issuing an alarm when the set temperature is not reached within a predetermined amount of time.

Prior Art Literature

Patent Literature

Patent Literature 1: Unexamined Patent Application Publication 2002-139483

### OVERVIEW OF THE INVENTION

### Problems to Be Solved by the Invention

As afore-described, even if the flaps are not completely closed, if the amount of opening is not large, the analysis is usually not impeded, and the operator often remains unaware of this and continues with the analysis. However, a situation such as this increases power consumption and operational cost as compared to the normal state. Not only that, this condition is not desirable in light of the contemporary global environmental concerns and interest in energy conservation.

A means has been available even in previous apparatuses for the complete forcible closure of the flaps. This operation is referred to as an “initialization.” With this operation, a drive pulse is continuously sent to the pulse motors that drive the flaps until an out-of-step condition occurs due to the increase in the load on the pulse motor that happens when a flap is completely closed. This operation allows the flaps to be completely closed unless there is a mechanical failure. However, a problem remains to be the absence of a means for checking whether or not the flaps have been completely closed.

The present invention has been made in light of the above-described situation, and it is the object of the present invention to provide a gas chromatograph that is equipped with a means for easily checking whether or not the supply/exhaust openings of an oven are closed and thus contribute to energy conservation.

### Means for Solving the Problems

To solve the afore-described problems, the gas chromatograph according to the present invention includes: a means for measuring the power of a heater; a memory means for storing predetermined standard power consumption of the heater as a function of a set temperature; and a flap closure checking means that compares, for any set temperature, the measured value of the power of the heater against the standard power consumption determined by a function for the set temperature and, if the former exceeds the latter by more than a predetermined limit value, judges that a closure failure has occurred with the flap.

### Effects of the Invention

Because of the afore-described configuration of the present invention, the operator can, at appropriate timings, determine that a flap is not closed and implement measures to correct the opening and closing of the flap, thus preventing power from being wasted.

### BRIEF DESCRIPTION OF THE FIGURES

FIG. 1 shows a block diagram of one embodiment of the present invention.

FIG. 2 is a graph showing one example of the standard power consumption of a heater.

FIG. 3 is a flowchart showing the operational sequence for checking the flap closure.

### EMBODIMENTS OF THE INVENTION

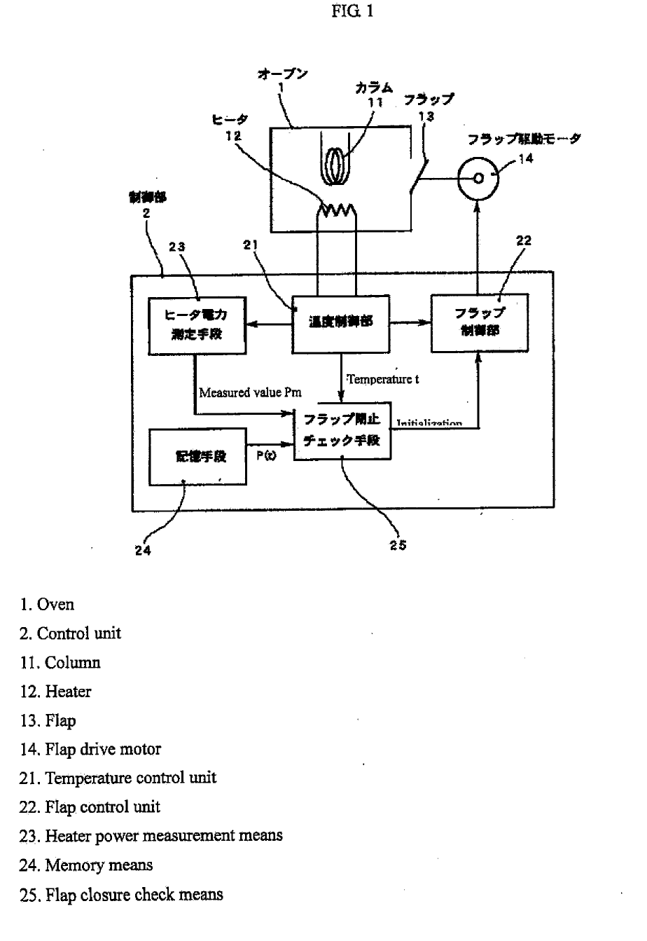

FIG. 1 is a block diagram showing the components that directly relate to the present invention in an embodiment of a gas chromatograph according to the present invention.

In the figure, a column 11 is housed within oven 1. The column 11 is heated by heater 12 to a predetermined temperature for the analysis. A flap 13 that opens and closes a supply/exhaust opening is disposed on the back surface of the oven 1. The flap 13 is opened and closed by a flap drive motor 14. As afore-described, one flap 13 each is in fact provided for gas supplying and gas exhausting purposes, but for simplicity, only one representative flap 13 is shown in this figure.

A control unit 2 controls the gas chromatograph and includes either an internal or an external computer. The temperature control unit 21 controls the power that is supplied to the afore-described heater 12 and keeps the temperature of the oven 1 at a predetermined value. The flap control unit 22 receives signal from the temperature control unit 21 and sends drive pulses to the flap drive motor 14 to adjust the amount of opening of the flap 13. The heater power measurement means 23 measures the current that is supplied to the heater 12 and uses Ohm's law to calculate the power consumed by the heater 12 based on the measured current value and the known resistance value of the heater 12.

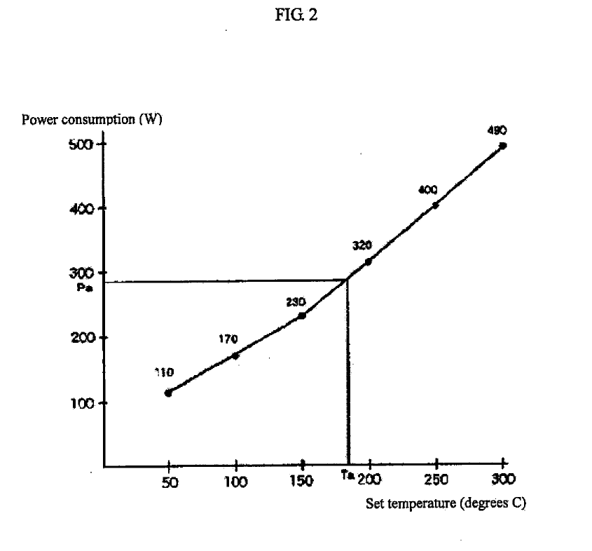

As for the power consumption of the heater 12, a number of standard values (standard power consumption values) when the opening and closing of flap 13 is being controlled normally is experimentally defined in advance. FIG. 2 shows one example of that. In the figure, the set temperature of oven 1 is plotted along the horizontal axis, and power consumption by heater 12 is plotted along the vertical axis. FIG. 2 shows one example of a standard power consumption that was determined experimentally at a number of set temperature points for a particular gas chromatograph. The plotted points are connected and interpolated using straight lines.

The straight line that connects the points can be represented by a linear function. For example, for the segment between 100 and 150 in FIG. 2, the standard power consumption P can be expressed by the following function of the set temperature t:

P=1.2t+50

Similarly, all other segments can be represented by different functions. The functions that represent all of the temperature segments are represented by function P(t). This function P(t) is stored in memory means 24. By calling this function, the standard power consumption Pa for any set temperature Ta can be determined.

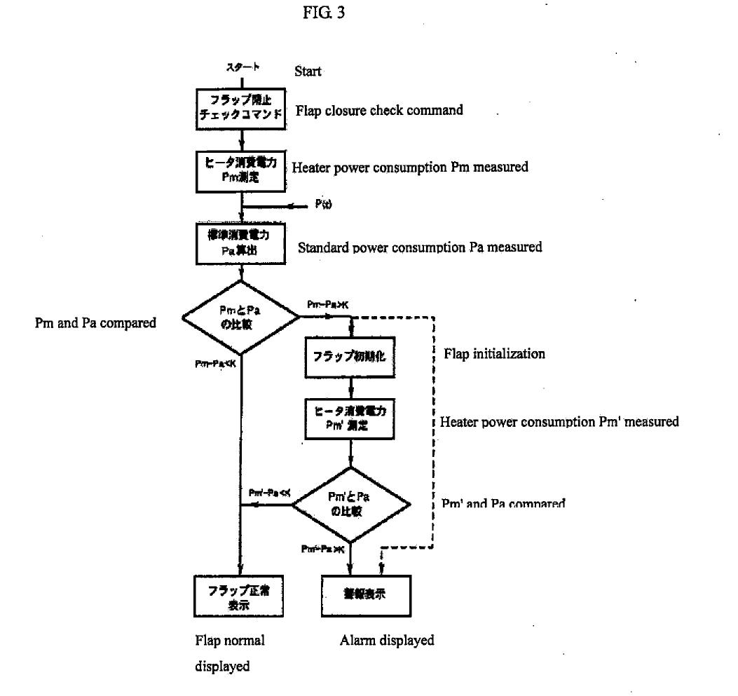

The flap closure checking means 25 uses the afore-described set temperature t of the oven 1, power consumption Pm of the heater 12 at that temperature and function P(t) to check the closure of flap 13. Its operation is described next with reference to FIG. 3 which is a flowchart showing the sequence of the flap closure check operation.

(1) When the oven temperature stabilizes at a set temperature Ta, the flap closure check command is executed.
(2) The power consumption Pm of heater 12 at the particular set temperature Ta of the oven is measured.
(3) The function P(t) stored in the memory means 24 is used to calculate the standard power consumption Pa for the set temperature Ta.
(4) Pm and Pa stated above are compared. If Pm−Pa>K, then a flap closure failure is judged to have occurred The flap initialization (forced flap closure) signal is issued. The forced closure of the flap 13 is attempted using the flap control unit 22.
(5) Here, K is the limit by which the measured power consumption can exceed the standard power consumption. It is set at some value such as 10% of Pa.

The power consumption Pm' of the heater 12 is measured again. Pm' and Pa are compared, and if Pm'−Pa>K, then it is judged that a flap closure failure has occurred, i.e., that some failure has occurred with the flap opening/closing system. An alarm is displayed.

(6) If the result of the comparison in (4) or (5) above results in Pm (or Pm')−Pa<K, it is judged that the position of flap 13 is normal. This fact is displayed by a lamp and the like, and the checking is terminated.

A more simplified procedure may be used where, in step (4) above, instead of issuing an initialization signal, an alarm is immediately displayed as identified by the dotted line in FIG. 3. In this case, the operator can respond to the alarm by manually performing the initialization or by performing necessary maintenance work.

### FEASIBILITY OF INDUSTRIAL USE

The present invention can be used with gas chromatographs.

### EXPLANATION OF THE NUMERICAL REFERENCES

1. Oven
2. Control unit
11. Column
12. Heater
13. Flap
14. Flap drive motor
21. Temperature control unit
22. Flap control unit
23. Heater power measurement means
24. Memory means
25. Flap closure checking means

What is claimed is:

1. A gas chromatograph comprising:
an oven that houses a column and is controlled to a set temperature;
a heater for heating said oven and whose power is controllable;
flaps for opening and closing supply/exhaust openings that connect the interior and exterior of said oven and whose degree of opening is controllable;
a means for measuring the power consumption of said heater
a memory means for storing predetermined standard power consumption of said heater as a function of said set temperature; and
a flap closure checking means for comparing, for any set temperature, the measured value of the power consumption of said heater against the standard power consumption determined by said function for the set temperature and, for judging that a closure failure has occurred with said flap if the former exceeds the latter by more than a predetermined limit value.

2. The gas chromatograph according to claim 1, wherein the chromatograph that is equipped with a means for forcibly closing said flap if said flap closure checking means judges that a closure failure has occurred with the flap.
